(19) United States
(12) Patent Application Publication
(10) Pub. No.: US 2014/0370749 A1
(43) Pub. Date: Dec. 18, 2014

(54) Electric Connector

(71) Applicant: ACES ELECTRONICS CO., LTD., Zhongli City (TW)

(72) Inventors: Nobukazu Kato, Fussa-shi (JP); Yohei Zama, Atsugi-shi (JP)

(73) Assignee: ACES ELECTRONICS CO., LTD., Zhongli City (TW)

(21) Appl. No.: 14/301,902

(22) Filed: Jun. 11, 2014

(30) Foreign Application Priority Data
Jun. 14, 2013 (JP) 2013-125555

(51) Int. Cl. H01R 13/6596; H01R 13/6461; H01R 13/6581

(52) U.S. Cl. CPC H01R 13/6596; H01R 13/6581; H01R 13/6461
USPC 439/607.31

(57) ABSTRACT

Provided is an electric connector, including: a housing placed on a circuit board and including a receiving concave portion formed by a substantially square-cylindrical-shaped inner wall surface and receiving a mating connector, and a center convex portion disposed between a pair of opposed walls forming the receiving concave portion; a plurality of terminals accommodated in a plurality of terminal grooves formed in each of the pair of the opposed walls, and contacting mating terminals of the mating connector; and a ground metal fitting connecting with a plate-shaped ground plate included in the mating connector, wherein the housing includes a space accommodating the ground metal fitting, which space is disposed in the central area between the pair of the opposed walls and extends in the arrangement direction of the terminals, the upper part of the space communicates with an opening formed in the center convex portion, extending in the arrangement direction of the terminals, and receiving the mating ground plate, the ground metal fitting includes a first connecting portion extending in the arrangement direction of the terminals, a second connecting portion extending in the arrangement direction of the terminals, and a connecting portion connecting the first connecting portion and the second connecting portion on the circuit board side such that the first connecting portion and the second connecting portion face to each other, and each of the lower ends of the first connecting portion and the second connecting portion is mounted on the circuit board.

### CROSS-REFERENCE TO RELATED APPLICATIONS

This application claims priority to Japanese Patent Application No. 2013-125555, filed on Jun. 14, 2013, which is incorporated herein by reference in its entirety.

### BACKGROUND OF THE INVENTION

The present invention related to an electric connector mounted on a circuit board and connected with a mating connector. There is a type of electric connector provided with a shell around a housing of the electric connector. This shell prevents noise from being mixed into electric signals so as to remove noise effect on the electric signals.

According to the electric connector of this type, ground terminals connected with a ground pattern of the circuit board are only provided at the four corners and the respective centers of both sides of the shell. In this case, electric signals are easily subjected to noise effect when transmitted via terminals not given ground terminals nearby.

### SUMMARY OF THE INVENTION

It is an object of the invention to provide an electric connector capable of removing noise effect on electric signals transmitted at high speed.

An electric connector of the invention includes: a housing placed on a circuit board and including a receiving concave portion formed by a substantially square-cylindrical-shaped inner wall surface and receiving a mating connector, and a center convex portion disposed between a pair of opposed walls forming the receiving concave portion; a plurality of terminals accommodated in a plurality of terminal grooves formed in each of the pair of the opposed walls, and contacting mating terminals of the mating connector; and a ground metal fitting connecting with a plate-shaped ground plate included in the mating connector, wherein the housing includes a space accommodating the ground metal fitting, which space is disposed in the central area between the pair of the opposed walls and extends in the arrangement direction of the terminals, the upper part of the space communicates with an opening formed in the center convex portion, extending in the arrangement direction of the terminals, and receiving the mating ground plate, the ground metal fitting includes a first connecting portion extending in the arrangement direction of the terminals, a second connecting portion extending in the arrangement direction of the terminals, and a connecting portion connecting the first connecting portion and the second connecting portion on the circuit board side such that the first connecting portion and the second connecting portion face to each other, and each of the lower ends of the first connecting portion and the second connecting portion is mounted on the circuit board.

Further, in the electric connector of the invention, the cross-sectional shape of the space of the housing in a direction crossing the arrangement direction of the terminals is a convex shape, the first connecting portion of the ground metal fitting is an elastic portion bended along a first inner wall forming the convex space, and the second connecting portion of the ground metal fitting is an elastic portion bended along a second inner wall forming the convex space.

Further, in the electric connector of the invention, each of the first connecting portion and the second connecting portion includes cut portions formed at predetermined intervals in the arrangement direction of the terminals.

According to the electric connector of the invention, noise effect on electric signals transmitted at high speed is removed.

### BRIEF DESCRIPTION OF THE DRAWINGS

FIG. 1 is a perspective view of a receptacle connector according to an embodiment;

FIG. 2 is a cross-sectional view of the receptacle connector according to the embodiment;

FIG. 3 is a perspective view of a ground metal fitting according to the embodiment;

FIG. 4 is a perspective view of a plug connector according to the embodiment;

FIG. 5 is a cross-sectional view of the plug connector according to the embodiment;

FIG. 6 is a perspective view illustrating a condition of the receptacle connector and the plug connector fitted to each other according to the embodiment; and

FIG. 7 is a cross-sectional view illustrating the condition of the receptacle connector and the plug connector fitted to each other according to the embodiment.

### DETAILED DESCRIPTION OF THE INVENTION

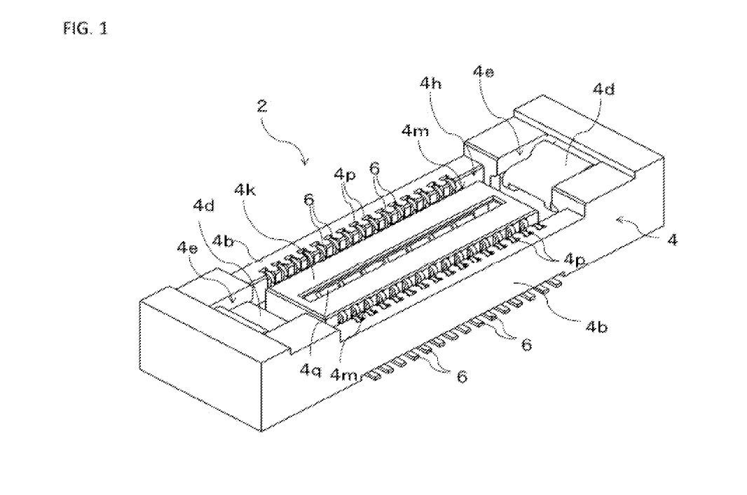

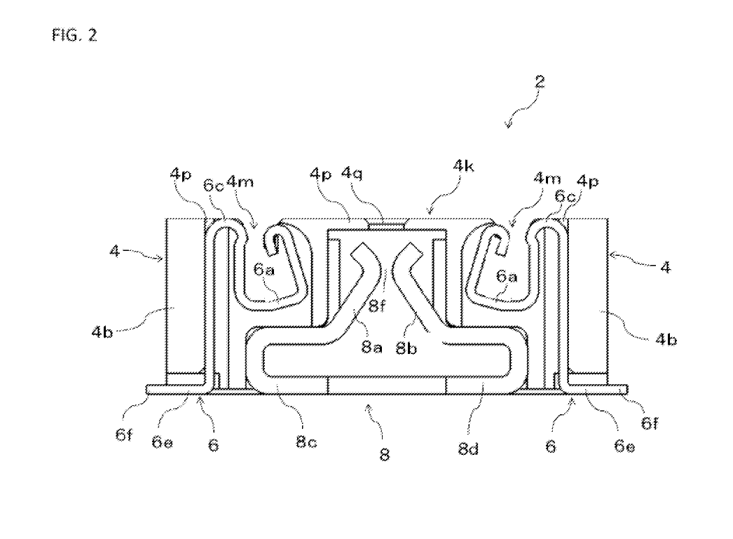

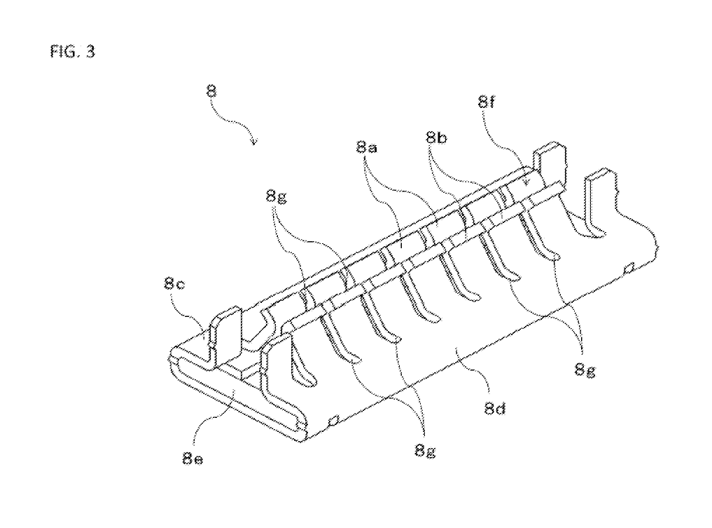

An electric connector according to an embodiment of the invention is hereinafter described with reference to the drawings. FIG. 1 is a perspective view illustrating a receptacle connector (electric connector) according to this embodiment. FIG. 2 is a cross-sectional view of FIG. 1. FIG. 3 is a perspective view illustrating a ground metal fitting disposed inside the receptacle connector.

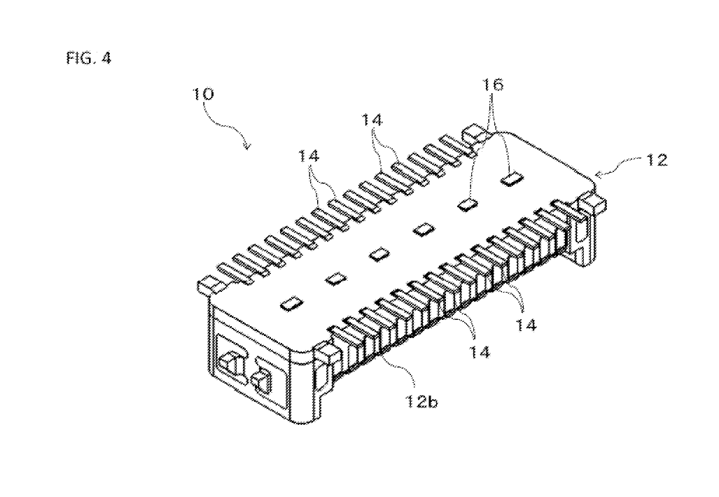

As illustrated in FIG. 1, the receptacle connector 2 includes a housing 4 having a rectangular shape in the plan view. The housing 4 is made of insulating material. Side walls 4b are provided at both ends of the housing 4 in the short direction, and extended in the longitudinal direction of the housing 4. Accommodating portions 4e are provided at both ends of the housing 4 in the longitudinal direction. Each of the accommodating portions 4e receives and accommodates a lock metal fitting 4d. The lock metal fitting 4d is a metal fitting which prevents separation of a plug connector 10 (see FIG. 4) from the receptacle connector 2 after the plug connector 10 is fitted to the receptacle connector 2.

A receiving concave portion 4h is formed at the center of the housing 4. The receiving concave portion 4h has a substantially square cylindrical shape surrounded by the inner wall surfaces of the side walls 4b and the accommodating portions 4e. The receiving concave portion 4h is configured to receive the plug connector 10. A center convex portion 4k is provided at the center of the receiving concave portion 4h. The center convex portion 4k extends in the longitudinal direction of the housing 4.

A receptacle fitting groove 4m is formed between the center convex portion 4k and one of the side walls 4b. The receptacle fitting groove 4m extends in the longitudinal direction of the housing 4. The receptacle fitting groove 4m is similarly formed between the center convex portion 4k and the other side wall 4b. This receptacle fitting groove 4m also extends in the longitudinal direction of the housing 4.

As illustrated in FIG. 2, a space is formed below the center convex portion 4k. The space has a convex cross-sectional shape, and extends in the longitudinal direction of the housing 4. The space is positioned in the central area between the one side wall 4b and the other side wall 4b. The upper part of the space communicates with a rectangular opening 4q formed at the center of the center convex portion 4k. A ground metal fitting 8 illustrated in FIG. 3 is disposed within the space. The ground metal fitting 8 extends in the longitudinal direction of the housing 4.

A plurality of terminal grooves 4p is formed on the inner wall surface side of the one side wall 4b at predetermined intervals. The terminal grooves 4p accommodate and hold corresponding terminals 6. Each of the terminals 6 accommodated and held in the terminal grooves 4p has a substantially S shape. A curved portion 6a is positioned within the receptacle fitting groove 4m, while a folded portion 6c is positioned at the upper end of the one side wall 4b. A lower end 6e is connected to the circuit board by soldering. A tip portion 6f of the lower end 6e is exposed to the outside of the one side wall 4b.

Similarly, a plurality of the terminal grooves 4p for accommodating and holding the terminals 6 are formed on the inner wall surface side of the other side wall 4b at predetermined intervals. Each of the terminals 6 accommodated and held in the terminal grooves 4p of the other side wall 4b similarly has a substantially S shape. The curved portion 6a is positioned within the receptacle fitting groove 4m, while the folded portion 6c is positioned at the upper end of the other side wall 4b. The lower end 6e is connected to the circuit board by soldering. The tip portion 6f of the lower end 6e is exposed to the outside of the other side wall 4b.

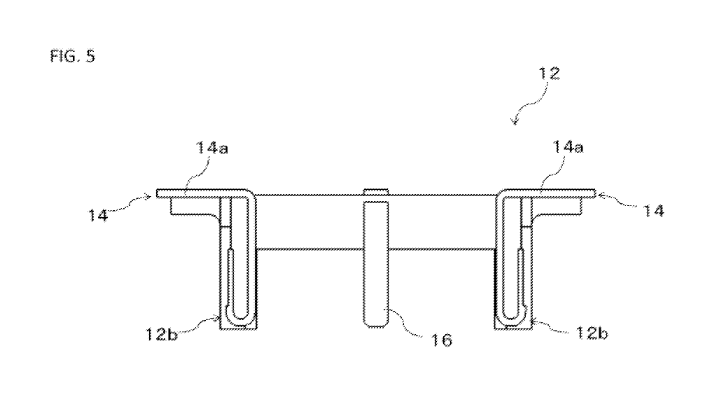

The ground metal fitting 8 includes a first connecting portion 8a disposed on the one side wall 4b side, and a second connecting portion 8b disposed on the other side wall 4b side. The first connecting portion 8a is connected with a ground plate 16 (see FIG. 5). The second connecting portion 8b is positioned opposed to the first connecting portion 8a, and connected with the ground plate 16 (see FIG. 5). A first base bottom portion 8c positioned beneath the first connecting portion 8a and a second base bottom portion 8d positioned beneath the second connecting portion 8b are connected by connecting portions 8e formed at both ends of the ground metal fitting 8 in the longitudinal direction.

The first connecting portion 8a is an elastic member which includes a bended portion positioned at the upper end of the first connecting portion 8a and bended toward the second connecting portion 8b, and an inclined portion inclined downward toward the first base bottom portion 8c from the bended portion. Similarly, the second connecting portion 8b is an elastic member which includes a bended portion positioned at the upper end of the second connecting portion 8b and bended toward the first connecting portion 8a, and an inclined portion inclined downward toward the second base bottom portion 8d from the bended portion.

A plurality of cut portions 8g are formed in the first connecting portion 8a at predetermined intervals. The cut portions 8g extend downward from the upper end of the first connecting portion 8a. Similarly, a plurality of the cut portions 8g are formed in the second connecting portion 8b at predetermined intervals. The cut portions 8g extend downward from the upper end of the second connecting portion 8b. A clearance 8f is formed between the bended portion of the first connecting portion 8a and the bended portion of the second connecting portion 8b. The clearance 8f extends in the arrangement direction of the terminals 6.

The entire lower surface of the first base bottom portion 8c and the entire lower surface of the second base bottom portion 8d are connected with the ground pattern of the circuit board.

FIG. 4 is a perspective view illustrating the plug connector (mating connector) according to this embodiment. FIG. 5 is a cross-sectional view of FIG. 4. As can be seen from FIG. 4, the plug connector 10 includes a rectangular housing 12 made of insulating material. Side walls 12b are provided at both ends of the housing 12 in the short direction. The side walls 12b extend in the longitudinal direction of the housing 12. Mating terminals 14 are arranged at predetermined intervals along the side walls 12b. As illustrated in FIG. 5, the ground plate 16 formed by insert molding is provided at the center of the housing 12. The ground plate 16 is a one-piece plate which extends in the longitudinal direction of the housing 12.

Each of the mating terminals 14 arranged on the one side wall 12b side has a substantially L shape. An upper end 14a of each of the mating terminals 14 on the one side wall 12b side is connected with a circuit pattern of a not-shown mating circuit board by soldering. Similarly, each of the mating terminals 14 arranged on the other side wall 12b side has a substantially L shape. The upper end 14a of each of the mating terminals 14 on the other side wall 12b side is connected with the circuit pattern of the not-shown mating circuit board by soldering.

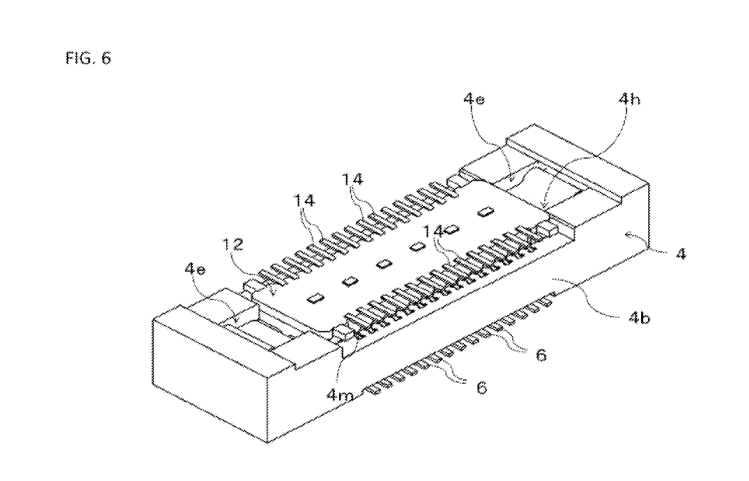

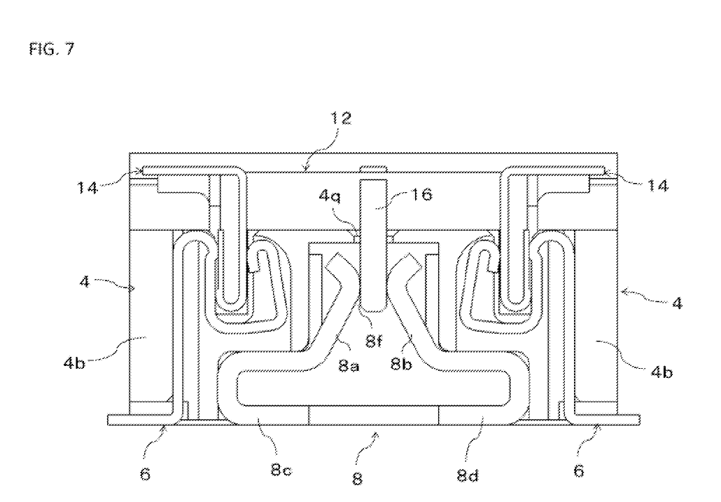

FIG. 6 is a perspective view illustrating a condition of the receptacle connector 2 and the plug connector 10 fitted to each other according to this embodiment. FIG. 7 is a cross-sectional view of FIG. 6. When fitted to the receptacle connector 2, the plug connector 10 is received by the receiving concave portion 4h of the receptacle connector 2 as illustrated in FIG. 6.

More specifically, electric connection between the mating terminals 14 and the terminals 6 is established by the fits between the one side wall 12b and the one receptacle fitting groove 4m and between the other side wall 12b and the other receptacle fitting groove 4m.

Simultaneously, the ground plate 16 is inserted through the opening 4q of the center convex portion 4k into the clearance 8f of the ground metal fitting 8. In this case, the first connecting portion 8a is constantly urged by an elastic force toward the right as viewed in FIG. 7, while the second connecting portion 8b is constantly urged by an elastic force toward the left as viewed in FIG. 7. Accordingly, the first connecting portion 8a and the second connecting portion 8b come into contact with the ground plate 16 by a sufficient contact force.

According to the receptacle connector 2 in this embodiment, the ground metal fitting 8 extended in the arrangement direction of the terminals 6 is positioned at the center of the housing 4. In this condition, the entire lower surface of the first base bottom portion 8c and the entire lower surface of the second base bottom portion 8d are both brought into continuous connection with the ground pattern of the circuit board. This structure can locate the ground metal fitting 8 close to all the terminals 6 at substantially the same distances from the respective terminals 6, and therefore can eliminate noise effect on electric signals transmitted via the respective terminals 6 at high speed.

Moreover, the cut portions 8g formed in each of the first connecting portion 8a and the second connecting portion 8b can produce uniform contact between the first and second connecting portions 8a and 8b and the ground plate 16.

The embodiment described herein has been presented for the purpose of easy understanding of the invention only, and is not intended to limit the scope of the invention. It should therefore be appreciated that the respective elements disclosed in this embodiment include all changes in design and equivalents without departing from the technical scope of the invention.

1. An electric connector, comprising:
a housing placed on a circuit board and including a receiving concave portion formed by a substantially square-cylindrical-shaped inner wall surface and receiving a mating connector, and a center convex portion disposed between a pair of opposed walls forming the receiving concave portion;
a plurality of terminals accommodated in a plurality of terminal grooves formed in each of the pair of the opposed walls, and contacting mating terminals of the mating connector; and
a ground metal fitting connecting with a plate-shaped ground plate included in the mating connector;
wherein
the housing includes a space accommodating the ground metal fitting, which space is disposed in the central area between the pair of the opposed walls and extends in the arrangement direction of the terminals;
the upper part of the space communicates with an opening formed in the center convex portion, extending in the arrangement direction of the terminals, and receiving the mating ground plate;
the ground metal fitting includes a first connecting portion extending in the arrangement direction of the terminals, a second connecting portion extending in the arrangement direction of the terminals, and a connecting portion connecting the first connecting portion and the second connecting portion on the circuit board side such that the first connecting portion and the second connecting portion face to each other, and
each of the lower ends of the first connecting portion and the second connecting portion is mounted on the circuit board.

2. The electric connector of claim 1, wherein
the cross-sectional shape of the space of the housing in a direction crossing the arrangement direction of the terminals is a convex shape;
the first connecting portion of the ground metal fitting is an elastic portion bended along a first inner wall forming the convex space; and
the second connecting portion of the ground metal fitting is an elastic portion bended along a second inner wall forming the convex space.

3. The electric connector of claim 1, wherein each of the first connecting portion and the second connecting portion includes cut portions formed at predetermined intervals in the arrangement direction of the terminals.

4. The electric connector of claim 2, wherein each of the first connecting portion and the second connecting portion includes cut portions formed at predetermined intervals in the arrangement direction of the terminals.
